(19) United States
(12) Patent Application Publication
(10) Pub. No.: US 2015/0184699 A1
(43) Pub. Date: Jul. 2, 2015

(54) ENGAGING DEVICE

(71) Applicant: Toyota Jidosha Kabushiki Kaisha, Toyota-shi Aichi-ken (JP)

(72) Inventors: Shotaro Kato, Susono-shi Shizuoka-ken (JP); Hiroaki Ebuchi, Hadano-shi Kanagawa-ken (JP); Yuji Iwase, Mishima-shi Shizuoka-ken (JP); Hidekazu Nagai, Susono-shi Shizuoka-ken (JP); Hiroto Hashimoto, Susono-shi Shizuoka-ken (JP)

(21) Appl. No.: 14/580,378

(22) Filed: Dec. 23, 2014

(30) Foreign Application Priority Data
Dec. 27, 2013 (JP) 2013-271407

(51) Int. Cl. F16D 27/09; F16D 27/118; F16D 11/14

(52) U.S. Cl. CPC F16D 27/09; F16D 11/14; F16D 27/118

(57) ABSTRACT

An ECU of an engaging device is configured to feedback-control a current value so as to realize an engagement indicator current required for moving a sleeve in a position in an axial direction in which dog teeth may mesh with dog teeth in engaging operation. This performs releasing operation based on temporal transition of the current value during the engaging operation.

### CROSS-REFERENCE TO RELATED APPLICATIONS

The present application claims priority to and incorporates by reference the entire contents of Japanese Patent Application No. 2013-271407 filed in Japan on Dec. 27, 2013.

### BACKGROUND OF THE INVENTION

1. Field of the Invention

The present invention relates to an engaging device.

2. Description of the Related Art

A meshing engaging device provided with coaxially arranged two members which engages both members by meshing respective tooth rows of the members with each other is known. As such engaging device, Japanese Laid-open Patent Publication No. 2001-280366 discloses a configuration of a dog clutch which engages/releases dog teeth by actuator driving, for example.

In the above-described engaging device, a configuration provided with a waiting mechanism such as a spring between an actuator and the dog tooth moved by the actuator is considered. In a situation in which engagement between the dog teeth does not advance because one dog tooth moved by the actuator and the other dog tooth are out of phase, the waiting mechanism may accumulate thrust provided from the actuator and allow the dog tooth to temporarily wait for movement, thereby absorbing impact force received by the dog teeth. When some kind of abnormality occurs in the waiting mechanism, the impact force which the dog tooth receives cannot be absorbed, so that there might be an effect that durability of the dog tooth is deteriorated.

### SUMMARY OF THE INVENTION

It is an object of the present invention to provide the engaging device capable of improving the durability.

According to one aspect of the present invention, an engaging device includes: a first member including engaged teeth arranged around an axis being a rotational center of a rotational element; a second member including engaging teeth arranged around the axis so as to be opposed to the engaged teeth, the second member being arranged coaxially with the first member; a rotating unit configured to relatively rotate the first member and the second member around the axis; a moving unit configured to provide thrust in an axial direction to the second member to move the second member in the axial direction; a control unit configured to perform engaging operation to engage the second member with the first member by meshing the engaging teeth with the engaged teeth and releasing operation to release an engaged state between the second member and the first member by separating the engaging teeth from the engaged teeth by controlling operation of the rotating unit and the moving unit; and a waiting mechanism, arranged between the moving unit and the second member, configured to accumulate the thrust in the axial direction provided from the moving unit and configured to allow the second member to wait for movement in the axial direction, wherein the control unit is configured to control a position of the second member in the axial direction through the waiting mechanism according to magnitude of a current value supplied to the moving unit, configured to feedback-control the current value to realize an engagement indicator current required for moving the second member to a position in the axial direction in which the engaging teeth may mesh with the engaged teeth in the engaging operation, and configured to perform the releasing operation based on temporal transition of the current value during the engaging operation.

According to another aspect of the present invention, in the engaging device, it is preferable that the moving unit includes an electromagnetic coil, a fixed portion arranged around the electromagnetic coil, and a movable portion forming a magnetic circuit of the electromagnetic coil together with the fixed portion and configured to operate the second member by moving in a predetermined direction by electromagnetic force generated in the magnetic circuit; the waiting mechanism is arranged between the movable portion and the second member; and the control unit is configured to control the position of the second member in the axial direction through the movable portion and the waiting mechanism by controlling a position of the movable portion in the axial direction according to the magnitude of the current value supplied to the electromagnetic coil of the moving unit and configured to perform the releasing operation when there is a drop of the current value in a time period after time required for the movable portion to arrive at a predetermined position and for the current value to reach the engagement indicator current at normal time of the waiting mechanism in the temporal transition of the current value during the engaging operation.

According to still another aspect of the present invention, in the above-described engaging device, it is preferable that the moving unit includes the electromagnetic coil, the fixed portion arranged around the electromagnetic coil, and the movable portion forming the magnetic circuit of the electromagnetic coil together with the fixed portion and configured to operate the second member by moving in the predetermined direction by the electromagnetic force generated in the magnetic circuit; the waiting mechanism is arranged between the movable portion and the second member; and the control unit is configured to control the position of the second member in the axial direction through the movable portion and the waiting mechanism by controlling the position of the movable portion in the axial direction according to the magnitude of the current value supplied to the electromagnetic coil of the moving unit and configured to perform the releasing operation when a lower limit value of the drop of the current value occurring in a time period before the time required for the movable portion to arrive at the predetermined position and for the current value to reach the engagement indicator current at the normal time of the waiting mechanism is not smaller than a predetermined threshold in the temporal transition of the current value during the engaging operation.

### BRIEF DESCRIPTION OF THE DRAWINGS

FIG. 1 is a cross-sectional schematic diagram of a schematic configuration of an engaging device according to one embodiment of the present invention;

FIG. 2 is a schematic diagram for illustrating movement of a sleeve and an armature when a waiting mechanism spring normally acts;

FIG. 3 is a schematic diagram for illustrating the movement of the sleeve and the armature when some kind of abnormality occurs such that the waiting mechanism spring cannot be expanded or contracted in an axial direction;

FIG. 4 is a time chart of temporal transition of a stroke amount of the armature and an actuator current at normal time and abnormal time of the waiting mechanism spring during engaging operation of the engaging device; and

FIG. 5 is a flowchart of an abnormality determining process of the waiting mechanism spring performed by the engaging device of this embodiment.

### DETAILED DESCRIPTION OF THE PREFERRED EMBODIMENTS

An embodiment of an engaging device according to the present invention is hereinafter described with reference to the drawings. Meanwhile, in the following drawings, the same reference sign is assigned to the same or corresponding portions and the description thereof is not repeated.

### Embodiment

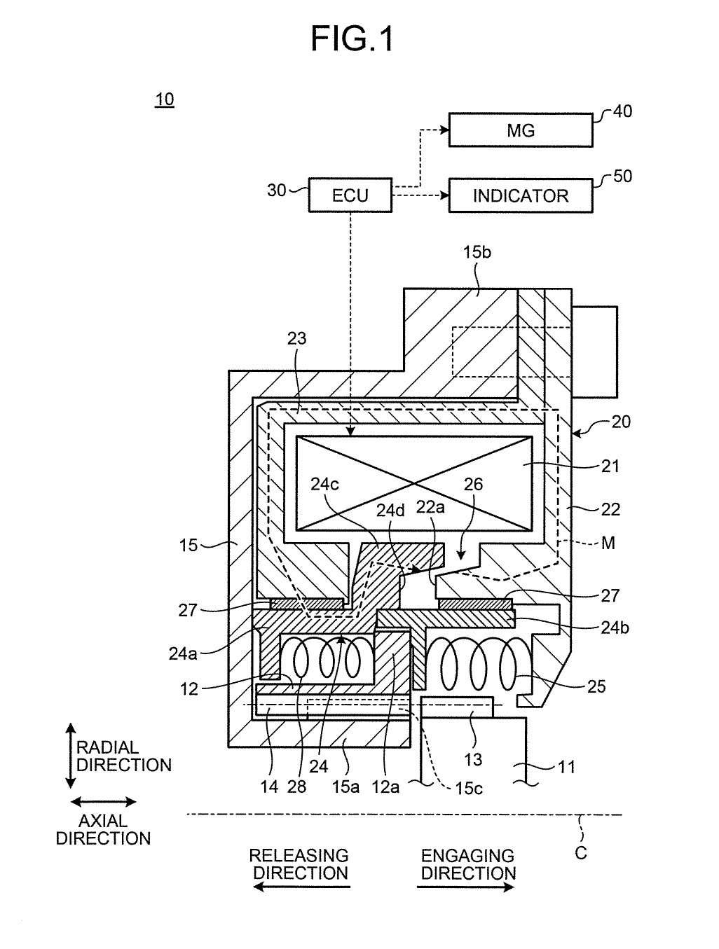

A configuration of an engaging device 10 according to one embodiment of the present invention is described with reference to FIG. 1. FIG. 1 is a cross-sectional schematic diagram of a schematic configuration of the engaging device according to one embodiment of the present invention.

The engaging device 10 illustrated in FIG. 1 is incorporated in a power transmission device which transmits power from a drive source such as an engine and a motor generator 40 to an output shaft in a hybrid vehicle, for example. The engaging device 10 is used as a braking device which restrains rotation of a part of rotational elements of the power transmission device and a clutch device which connects two rotational elements to each other in order to control the power transmitted from the power transmission device to the output shaft, for example. Meanwhile, a detailed structure such as an entire configuration of the power transmission device is not directly related to the gist of the present invention, so that the description thereof is omitted.

The engaging device 10 is provided with a piece 11 (first member), a sleeve 12 (second member), a hub bracket 15, an electromagnetic actuator 20 (moving unit), and an electronic control unit 30 (ECU) as illustrated in FIG. 1.

The piece 11 and the sleeve 12 are arranged around the above-described rotational element. The rotational element is configured to rotate around an axis C indicated by a dashed-dotted line in a horizontal direction in a lower part of FIG. 1; in the following description, the horizontal direction in the drawing is referred to as an “axial direction” of the rotational element and a vertical direction is referred to as a “radial direction” of the rotational element unless otherwise noted. A direction around the axis C is referred to as a “circumferential direction” of the rotational element.

The piece 11 integrally rotates with the rotational element around the axis C while interlocking with the same. Movement in the axial and radial directions of the piece 11 is restrained.

The sleeve 12 is arranged on an outer side of the piece 11 in the radial direction. The sleeve 12 is splined to the hub bracket 15. The hub bracket 15 is fixed to a case (not illustrated) including components of the power transmission device. That is to say, the sleeve 12 is splined to the hub bracket 15 so as to be configured to be movable in the axial direction, and movement in the radial direction and rotation around the axis C thereof are restrained. The sleeve 12 includes a sandwiched portion 12a elongating toward an outer side in the radial direction.

The piece 11 and the sleeve 12 may engage/release an inner peripheral surface of the sleeve 12 with/from an outer peripheral surface of the piece 11 by the movement of the sleeve 12 in the axial direction. A plurality of dog teeth 13 (engaged teeth) is arranged on the outer peripheral surface of the piece 11 in the circumferential direction around the axis C toward the outer side in the radial direction. A plurality of dog teeth 14 (engaging teeth) is arranged on the inner peripheral surface of the sleeve 12 in the circumferential direction around the axis C toward an inner side in the radial direction. The dog teeth 13 and 14 form a meshing dog clutch. The sleeve 12 moves in a direction to approach the piece 11 (engaging direction) and the dog teeth 14 of the sleeve 12 and the dog teeth 13 of the piece 11 are closely interlocked to mesh with each other, then the piece 11 and the sleeve 12 may be engaged with each other. It is possible to lock the rotation of the rotational element interlocking with the piece 11 by splining the sleeve 12 to the piece 11. When the sleeve 12 moves in a direction to separate from the piece 11 (releasing direction), thereby separating the dog teeth 14 of the sleeve 12 from the dog teeth 13 of the piece 11, it is possible to release an engaged state between the sleeve 12 and the piece 11.

In FIG. 1, the sleeve 12 is arranged to the left of the piece 11 and it is configured that, when the sleeve 12 moves rightward, this engages with the piece 11, and when this moves leftward, this is released from the piece 11. In the following description, a direction to the right in FIG. 1 is also referred to as the “engaging direction” and a direction to the left is also referred to as the “releasing direction”.

The electromagnetic actuator 20 is a power source which generates drive force in the axial direction to move the sleeve 12 in the axial direction. As illustrated in FIG. 1, the electromagnetic actuator 20 of this embodiment is specifically an electromagnetic solenoid actuator. The electromagnetic actuator 20 is arranged around the rotational element which rotates around the axis C and on the outer side of the piece 11 and sleeve 12 in the radial direction.

The electromagnetic actuator 20 is provided with an electromagnetic coil 21, an inner yoke 22 (fixed portion), an outer yoke 23 (fixed portion), an armature 24 (movable portion), a return spring 25, and a waiting mechanism spring 28 (waiting mechanism).

The inner yoke 22 is arranged from a side in the engaging direction around the electromagnetic coil 21 and the outer yoke 23 is arranged from a side in the releasing direction around the electromagnetic coil 21. The inner yoke 22 and the outer yoke 23 are connected to each other on an outer side of the electromagnetic coil 21 in the radial direction to be fixed to the case together. That is to say, the inner yoke 22 and the outer yoke 23 serve as the fixed portions fixedly arranged around the electromagnetic coil 21 so as to sandwich the electromagnetic coil 21 from both sides in the axial direction. The inner yoke 22 and the outer yoke 23 are not connected to each other on an inner side of the electromagnetic coil 21 in the radial direction but form an opening 26 on a part on the inner side of the electromagnetic coil 21 in the radial direction. The inner yoke 22 and the outer yoke 23 are formed of magnetic materials.

The armature 24 is arranged on an inner side of the inner yoke 22 and the outer yoke 23 in the radial direction and on the outer side of the sleeve 12 in the radial direction. The armature 24 is placed so as to be movable in the axial direction and may provide thrust to the sleeve 12 by the movement thereof in the axial direction.

The armature 24 is formed of two members which are a first member 24a and a second member 24b. The first member 24a of the armature 24 is arranged so as to be able to abut the sandwiched portion 12a of the sleeve 12 from the side in the releasing direction in the axial direction and the second member 24b is arranged so as to be able to abut the sandwiched portion 12a of the sleeve 12 from the side in the engaging direction. That is to say, the armature 24 is arranged in a state of sandwiching the sandwiched portion 12a of the sleeve 12 from the both sides in the axial direction and is configured to be able to improve an interlocking property between the armature 24 and the sleeve 12. This configuration may secure an assembling property of the sleeve 12 arranged between the first member 24a and the second member 24b.

The first member 24a of the armature 24 is supported on the inner side of the outer yoke 23 in the radial direction through a supporting member 27 such as plating and bushing, and the second member 24b is supported on the inner side of the inner yoke 22 in the radial direction through the supporting member 27. That is to say, the first member 24a and the second member 24b are individually supported by the fixed portions (inner yoke 22 and outer yoke 23). That is to say, the armature 24 has two supporting points by the fixed portions in the axial direction to be both-end supported (two-point supported) and is configured to be able to improve stability in the movement in the axial direction and to efficiently transmit the thrust to the sleeve 12.

The armature 24 is formed as an integral member by press fitting of the second member 24b to the first member 24a. According to this, it becomes possible to perform integral operation while realizing improvement in performance by compact dimension in the radial and axial directions, improvement in the assembling property, and reduction in inertia even when the armature 24 is formed of a plurality of members. Meanwhile, the first member 24a and the second member 24b of the armature 24 may be fastened by a fastening unit such as a bolt.

The first member 24a of the armature 24 includes a protrusion 24c protruding toward an outer side in the radial direction and protruding on the side in the engaging direction in the axial direction. The protrusion 24c is inserted into the opening 26 between the inner yoke 22 and the outer yoke 23. A stopper surface 24d orthogonal to an operating direction of the armature 24 is provided on an end face on the side in the engaging direction of the protrusion 24c. On the other hand, a stopper surface 22a is provided on an end face on the side in the releasing direction of the inner yoke 22 in a position opposed to the stopper surface 24d of the armature 24. When the armature 24 moves in the engaging direction, the stopper surface 24d of the armature 24 abuts the stopper surface 22a of the inner yoke 22, so that the movement of the armature 24 in the engaging direction may be stopped.

The first member 24a of the armature 24 is formed of the magnetic material and the second member 24b is formed of a non-magnetic material. According to this, it becomes possible to block a magnetic path other than that in a necessary part without providing an air gap and the like on supporting portions (supporting members 27) between the first and second members 24a and 24b and the fixed portions (inner yoke 22 and outer yoke 23).

The supporting portions of two-point support between the armature 24 and the fixed portions are set such that dimensions thereof in the radial direction are the same. That is to say, the supporting portion between the first member 24a of the armature 24 and the outer yoke 23 and the supporting portion between the second member 24b thereof and the inner yoke 22 are arranged in the same positions in the radial direction. Herein, the phrase “the positions of the both supporting portions in the radial direction are the same” is intended to mean that a dimensional deviation in the radial direction of the supporting portions is within a predetermined range (for example, ±0.2 mm or smaller). According to this, processing accuracy may be improved and supporting accuracy may be improved.

The return spring 25 is arranged between the second member 24b of the armature 24 and the inner yoke 22. The return spring 25 being a compression spring, for example, is held in an appropriately compressed state to energize the armature 24 in the releasing direction. The more the armature 24 moves in the engaging direction, that is to say, the greater a meshing degree between the sleeve 12 and the piece 11, the larger energizing force in the releasing direction the return spring 25 generates.

The waiting mechanism spring 28 is provided between the first member 24a of the armature 24 and the sandwiched portion 12a of the sleeve 12. The waiting mechanism spring 28 is arranged so as to be able to expanded and contracted in the axial direction according to a relative positional relationship in the axial direction between the armature 24 and the sandwiched portion 12a of the sleeve 12.

The hub bracket 15 includes an inner cylindrical portion 15a elongating so as to be adjacent to the piece 11 to be splined to the sleeve 12 around the axis C. The hub bracket 15 has a shape to elongate from the inner cylindrical portion 15a toward an outer side in the radial direction so as to cover the sleeve 12 and the electromagnetic actuator 20 along a shape of the electromagnetic actuator 20 and is fixed with bolt to the case (not illustrated) at an outer edge end 15b. The inner cylindrical portion 15a of the hub bracket 15 is arranged on the inner side of the sleeve 12 in the radial direction and a plurality of spline teeth 15c is arranged on an outer peripheral surface of the inner cylindrical portion 15a in the circumferential direction toward the outer side in the radial direction. The sleeve 12 is splined to the hub bracket 15 and supported so as to be movable in the axial direction by the dog tooth 14 inserted between the spline teeth 15c.

The ECU 30 is a control device which controls each unit of the vehicle based on information of various sensors in the vehicle. In this embodiment, the ECU 30 is connected to the electromagnetic actuator 20 of the engaging device 10 and may control engagement/release of the engaging device 10 by controlling the movement of the sleeve 12 in the axial direction by controlling operation of the electromagnetic actuator 20.

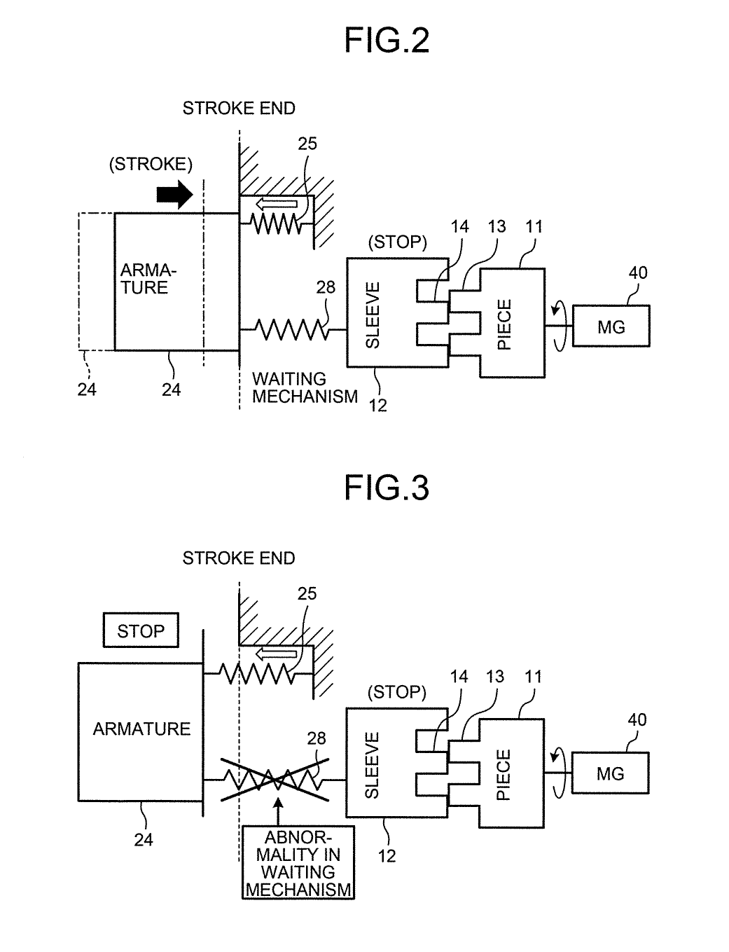

Meanwhile, in this embodiment, there is the motor generator 40 included in the power transmission device of the vehicle as the rotational element interlocking with the piece 11. The ECU 30 may control the rotation of the piece 11 in the circumferential direction (rotational direction) by controlling operation of the motor generator 40 (refer to FIGS. 2 and 3). In this embodiment, the motor generator 40 serves as a rotating unit which relatively rotates the piece 11 and the sleeve 12 around the axis C. The ECU 30 controls the operation of the electromagnetic actuator 20 and the motor generator 40, thereby serving as a control unit to control engaging operation and releasing operation of the engaging device 10.

An indicator 50 (informing unit) of the vehicle is connected to the ECU 30 to inform a driver and a mechanic of the vehicle of information of the vehicle (for example, information of occurrence of abnormality in the waiting mechanism spring 28 to be described later) by character information and audio information through the indicator 50. The ECU 30 is physically an electronic circuit mainly formed of a well-known micro computer including a central processing unit (CPU), a random access memory (RAM), a read only memory (ROM), an interface and the like. Each function of the ECU 30 is realized by loading an application program held by the ROM on the RAM and executing the same by the CPU, thereby operating various devices in the vehicle under the control of the CPU and reading and writing data from and to the RAM and ROM.

In such engaging device 10, when the electromagnetic coil 21 of the electromagnetic actuator 20 is in a non-excited state, the electromagnetic actuator 20 stops and the sandwiched portion 12a of the sleeve 12 receives the energizing force of the return spring 25 in the releasing direction through the second member 24b of the armature 24. By the energizing force, the sleeve 12 is held in a position on the inner cylindrical portion 15a of the hub bracket 15 separated from the piece 11 to be put into a non-meshed state with the piece 11 as illustrated in FIG. 1. That is to say, when the electromagnetic actuator 20 is in the non-excited state, the engaging device 10 is in a released state and the piece 11 may rotate while interlocking with the rotational element.

When the electromagnetic coil 21 is excited in response to a control instruction from the ECU 30, a magnetic circuit M which passes through the inner yoke 22, the outer yoke 23, and the first member 24a of the armature 24 formed of the magnetic materials arranged around the electromagnetic coil 21 is formed. The magnetic circuit M is formed so as to pass across a gap between the stopper surface 24d of the protrusion 24c of the armature 24 and the stopper surface 22a of the inner yoke 22 as indicated by a dotted arrow in FIG. 1. Therefore, the armature 24 is magnetically attracted toward the inner yoke 22 while being guided by the inner peripheral surfaces of the inner yoke 22 and the outer yoke 23. The armature 24 moves in the engaging direction against the return spring 25 by this magnetic attractive force (electromagnetic force). The waiting mechanism spring 28 transmits pressing force received from the armature 24 to the sandwiched portion 12a of the sleeve 12 with the movement of the armature 24 in the engaging direction. According to this, the sandwiched portion 12a of the sleeve 12 receives the thrust and the sleeve 12 also moves in the engaging direction while interlocking with the armature 24, and it is put into the meshed state in which the dog teeth 14 of the sleeve 12 mesh with the dog teeth 13 of the piece 11. That is to say, when the electromagnetic actuator 20 is in the excited state, the engaging device 10 is put into the engaged state, so that it is possible to stop the rotation of the rotational element connected to the piece 11.

A function of the waiting mechanism spring 28 is herein further described with reference to FIG. 2. FIG. 2 is a schematic diagram for illustrating movement of the sleeve and the armature when the waiting mechanism spring normally acts.

As illustrated in FIG. 2, there might be a situation in which, although the sleeve 12 starts engaging with the piece 11 by the movement of the sleeve 12 in the engaging direction, the dog teeth 14 of the sleeve 12 do not mesh well with the dog teeth 13 of the piece 11 because the piece 11 and the sleeve 12 are out of phase, for example. In such situation, end faces of the dog tooth 14 of the sleeve 12 and the dog tooth 13 of the piece 11 collide with each other and the piece 11 inhibits further movement of the sleeve 12 in the engaging direction, so that the piece 11 and the sleeve 12 do not completely engage with each other. That is to say, the situation is such that the movement of the sleeve 12 in the engaging direction is temporarily stopped. In the electromagnetic actuator 20 of this embodiment, the armature 24 may continuously move in the engaging direction to a stroke end (for example, a position in which the second member 24b of the armature 24 abuts the inner yoke 22) while compressing the waiting mechanism spring 28 even in such situation (refer to FIG. 2). After it transits to a situation in which the piece 11 and the sleeve 12 are in phase with each other, the sleeve 12 is pushed in the engaging direction by the energizing force of the waiting mechanism spring 28 to move to a position in which the dog teeth 14 of the sleeve 12 sufficiently mesh with the dog teeth 13 of the piece 11.

In this manner, when the piece 11 and the sleeve 12 are out of phase and the sleeve 12 receives predetermined or larger reaction force in the releasing direction from the piece 11, the electromagnetic actuator 20 of this embodiment allows the sleeve 12 to wait for the movement in the engaging direction and allows the armature 24 to continuously move in the engaging direction by an action of the waiting mechanism spring 28. According to this, it is possible to make a relative distance between the armature 24 and the sleeve 12 short to compress the waiting mechanism spring 28, thereby accumulating the thrust transmitted from the armature 24 in the waiting mechanism spring 28. When the piece 11 and the sleeve 12 are in phase with each other and the reaction force which the sleeve 12 receives is reduced, the sleeve 12 is accelerated again to rapidly move in the engaging direction by using the thrust accumulated in the waiting mechanism spring 28, and the dog teeth 14 of the sleeve 12 may be engaged with the dog teeth 13 of the piece 11. As a result, the electromagnetic actuator 20 of this embodiment may perform the engaging operation between the sleeve 12 being an operated member and the piece 11 more surely by the waiting mechanism spring 28 included.

A function of the electromagnetic actuator 20 by such waiting mechanism spring 28 may also be referred to as a so-called ratchet function to maintain a position of the sleeve 12 or retreat the sleeve 12 in a stroke direction when this receives the reaction force in the axial direction (releasing direction) from a side of the piece 11 to idle the piece 11. The waiting mechanism spring 28 also has a function to reduce a load to avoid the load at the time of the collision between the dog tooth 14 of the sleeve 12 and the dog tooth 13 of the piece 11.

There is a case in which some kind of abnormality occurs in the waiting mechanism spring 28 such that this cannot be expanded or contracted in the axial direction because an attaching portion thereof to the armature 24 or the sleeve 12 is detached and this falls between the armature 24 and the sleeve 12 or this has a foreign material caught therein, for example. When such abnormality occurs, the waiting mechanism spring 28 cannot exert the function as the above-described waiting mechanism. FIG. 3 is a schematic diagram for illustrating the movement of the sleeve and the armature when the abnormality occurs in such waiting mechanism spring.

As illustrated in FIG. 3, when some kind of abnormality occurs in the waiting mechanism spring 28 and this cannot be expanded or contracted in the axial direction, a relative position between the armature 24 and the sleeve 12 cannot be changed. Therefore, when the sleeve 12 and the piece 11 are out of phase and the end faces of the dog tooth 14 of the sleeve 12 and the dog tooth 13 of the piece 11 collide with each other as described above, the movement of the armature 24 in the engaging direction temporarily stops with temporal stop of the movement of the sleeve 12 in the engaging direction. When the piece 11 and the sleeve 12 are in phase with each other and the reaction force which the sleeve 12 receives is decreased, the armature 24 and the sleeve 12 are accelerated again to rapidly move in the engaging direction by the thrust generated by the electromagnetic actuator 20 and transmitted from the armature 24, so that the dog teeth 14 of the sleeve 12 can be engaged with the dog teeth 13 of the piece 11.

In this manner, in the state in which the abnormality occurs in the waiting mechanism spring 28, the thrust transmitted from the armature 24 cannot be absorbed by the waiting mechanism spring 28, so that this is directly transmitted to the sleeve 12 and the piece 11 in a state in which the dog teeth 13 and 14 are in contact with each other. Therefore, the dog teeth 13 and 14 receive excessive impact force and durability of the dog teeth 13 and 14 might be deteriorated. In order to avoid such a situation, it is preferable that, when the abnormality occurs in the waiting mechanism spring 28, the occurrence of the abnormality may be rapidly detected.

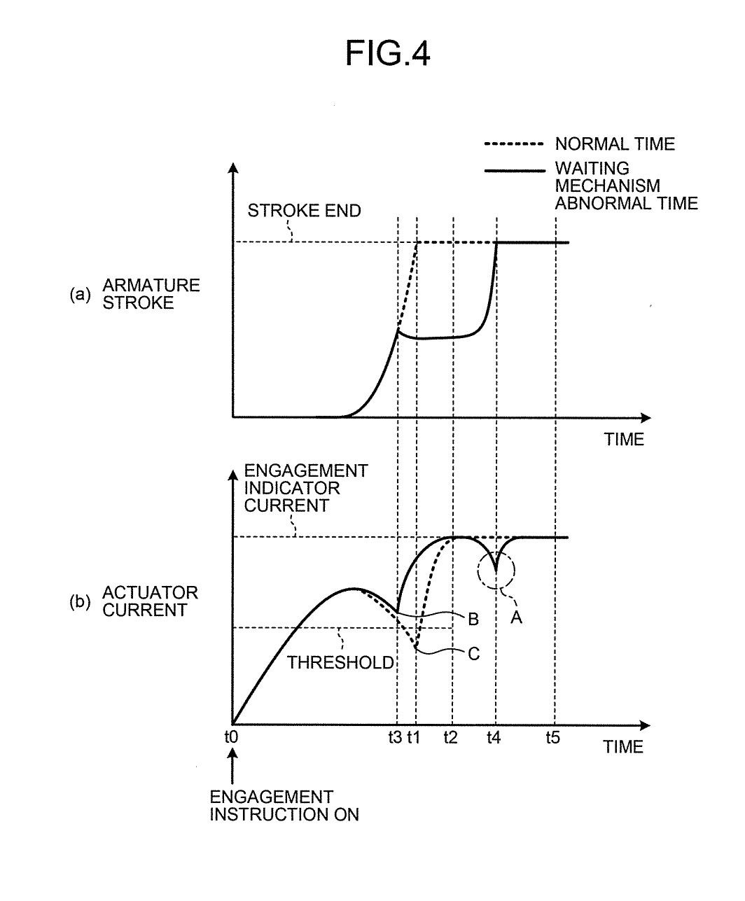

A method of determining the abnormality in the waiting mechanism spring 28 in this embodiment is schematically described with reference to FIG. 4. FIG. 4 is a time chart of temporal transition of a stroke amount of the armature and an actuator current at normal time and abnormal time of the waiting mechanism spring during the engaging operation of the engaging device.

In the time chart in FIG. 4, (a) illustrates the stroke amount being the position of the armature 24 in the engaging direction (represented as “armature stroke” in the drawing) and (b) illustrates a current value flowing through the electromagnetic coil 21 of the electromagnetic actuator 20 (represented as “actuator current in the drawing). In FIG. 4, as the stroke amount of the armature 24 transits upward, the armature 24 moves more in the engaging direction. In FIG. 4, as the current value transits upward, the current flows more in a direction in which the thrust in the engaging direction which the electromagnetic actuator 20 allows the armature 24 to output increases. In FIG. 4, the temporal transition of the armature stroke and of the actuator current at the abnormal time of the waiting mechanism spring 28 are indicated by solid lines and the temporal transition of the armature stroke and the actuator current at the normal time of the waiting mechanism spring 28 are indicated by dotted lines. Meanwhile, in FIG. 4, “temporal transition at the normal time” is intended to mean the temporal transition when the operation described with reference to FIG. 2 is performed and “temporal transition at the abnormal time” is intended to mean the temporal transition when the operation described with reference to FIG. 3 is performed.

In a state in which the waiting mechanism spring 28 normally acts, as described with reference to FIG. 2, even when the end faces of the dog tooth 14 of the sleeve 12 and the dog tooth 13 of the piece 11 collide with each other and the movement of the sleeve 12 in the engaging direction temporarily stops, the armature 24 continues to move in the engaging direction. There might be a situation in which the end faces of the dog tooth 14 of the sleeve 12 and the dog tooth 13 of the piece 11 do not collide with each other and the dog tooth 14 of the sleeve 12 may enter between the dog teeth 13 of the piece 11; the movement of the sleeve 12 in the engaging direction does not stop in this case, so that the armature 24 also continues to move in the engaging direction naturally. That is to say, as indicated by the dotted line in (a) in FIG. 4, when the waiting mechanism spring 28 is normal, the armature 24 moves to the stroke end in a predetermined time to complete the stroke at time t1 regardless of whether the sleeve 12 collides with the piece 11 and whether the sleeve 12 moves.

On the other hand, in a state in which the abnormality occurs in the waiting mechanism spring 28, as described with reference to FIG. 3, when the end faces of the dog tooth 14 of the sleeve 12 and the dog tooth 13 of the piece 11 collide with each other and the movement of the sleeve 12 in the engaging direction temporarily stops, the movement of the armature 24 in the engaging direction also temporarily stops. When the sleeve 12 is in phase with the piece 11 and moves again, the movement of the armature 24 is also restarted. That is to say, as indicated by the solid line in (a) in FIG. 4, when some kind of abnormality occurs in the waiting mechanism spring 28, if the sleeve 12 collides with the piece 11 and stops moving in the engaging direction, the armature 24 stops in a temporary stop position in the axial direction when the sleeve 12 stops moving (time t3 in FIG. 4) and moves to the stroke end when the movement of the sleeve 12 is restarted (time t4 in FIG. 4).

In this manner, the temporal transition of the stroke amount of the armature 24 during the engaging operation is different between the normal time and the abnormal time of the waiting mechanism spring 28. Therefore, it is considered that the occurrence of the abnormality in the waiting mechanism spring 28 may be detected by observation of the temporal transition of the stroke amount of the armature 24. However, a conventional electromagnetic actuator generally has a configuration without a stroke sensor which detects the stroke amount of the armature 24. It is difficult to provide the stroke sensor around the armature 24 due to limitation in installation space and an increase in cost. Therefore, the configuration capable of determining the abnormality in the waiting mechanism spring 28 without adding the sensor to directly measure the stroke amount of the armature 24 is desirable.

Therefore, in this embodiment, the abnormality in the waiting mechanism spring 28 is determined based on the temporal transition of the current value (actuator current) flowing through the electromagnetic coil 21 of the electromagnetic actuator 20 while the armature 24 arrives at the stroke end at the time of the engaging operation.

As illustrated in (b) in FIG. 4, when an engagement instruction to execute the engaging operation is turned on at time t0, the actuator current is feedback-controlled to be a predetermined engagement indicator current. Herein, the engagement indicator current is the current value required for moving the sleeve 12 to a position in the engaging direction in which the sleeve 12 may mesh with the piece 11. In other words, the engagement indicator current is a target current value required for generating the thrust for the armature 24 to move to the stroke end against the energizing force of the return spring 25 transmitted through the sleeve 12.

As indicated by the dotted line in (b) FIG. 4, in a state in which the waiting mechanism spring 28 normally acts, the actuator current exhibits behavior to drop once without monotorically increasing to the engagement indicator current by an effect of back electromotive force generated in the electromagnetic coil 21. In more detail, when the current value is low just after time t0 at which the feedback control is started, the actuator current monotonically increases toward the engagement indicator current, but when the current value gradually increases and the back electromotive force is generated so as to cancel out the increase in current value, the current value starts decreasing. When the armature 24 arrives at the stroke end and stops moving at time t1, the actuator current increases again to finally reach the engagement indicator current at time t2. In this manner, when the waiting mechanism spring 28 is normal, the actuator current drops once and then reaches the engagement indicator current during the engaging operation. Time required for the actuator current to reach the engagement indicator current after the engagement instruction is issued is time t2 in FIG. 4; this required time t2 is determined according to a condition such as magnitude of the engagement indicator current, the stroke amount of the armature 24, a method of the feedback control, parameter setting, and hardware of the electromagnetic actuator 20 such as coil winding wire.

On the other hand, as indicated by the solid line in (b) in FIG. 4, in the state in which the abnormality occurs in the waiting mechanism spring 28, the actuator current exhibits behavior to reach the target current after dropping twice. In more detail, the actuator current temporarily takes a downward turn by the effect of the back electromotive force generated in the electromagnetic coil 21 after time t0 as at the above-described normal time, but this takes an upward turn when the movement of the armature 24 in the axial direction temporarily stops at time t3 before time t1 at which this arrives at the stroke end described above. When the movement of the armature 24 in the axial direction is started again after time t2, the actuator current starts decreasing again by the effect of the back electromotive force. When the armature 24 arrives at the stroke end and stops moving at time t4, this takes an upward turn again to finally reach the target current. That is to say, at time t3 at which the movement of the armature 24 temporarily stops, a first drop of the actuator current occurs, and at time t4 at which the armature 24 arrives at the stroke end, a second drop of the actuator current (region A in the drawing) occurs. Especially, the second drop (region A) occurs at time t4 after required time t2 for the armature 24 to arrive at the stroke end and for the actuator current to reach the engagement indicator current at the above-described normal time because the time required for the armature 24 to arrive at the stroke end is longer than that at the normal time by time in which the armature 24 temporarily stops the movement in the engaging direction.

Therefore, in this embodiment, when the drop (region A illustrated in (b) in FIG. 4) occurs in the actuator current in a time period after the required time t2 for the armature 24 to arrive at the stroke end and for the actuator current to reach the engagement indicator current when the waiting mechanism spring 28 is normal, it is determined that some kind of abnormality occurs in the waiting mechanism spring 28 and this cannot be expanded or contracted in the axial direction.

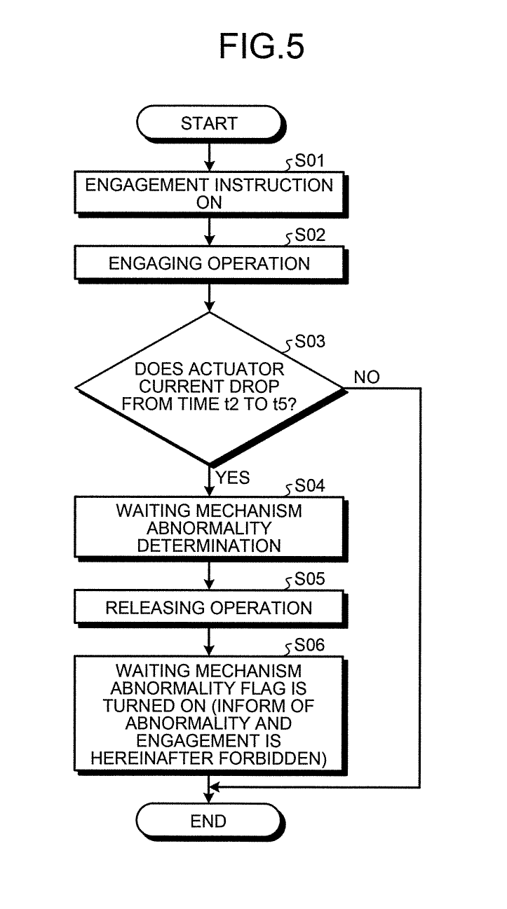

The operation of the engaging device 10 according to this embodiment is described with reference to FIG. 5. FIG. 5 is a flowchart of an abnormality determining process of the waiting mechanism spring performed by the engaging device of this embodiment. The process of the flowchart illustrated in FIG. 5 is performed when the engaging operation is started, for example, by the ECU 30. Meanwhile, the flowchart in FIG. 5 is described based on the configuration in which the engaging device 10 of this embodiment is incorporated in the power transmission device of the hybrid vehicle as illustrated above.

At step S01, the engagement instruction is turned on. The ECU 30 comprehensively determines a travel state and the like of the vehicle and activates (turns on) the engagement instruction when this determines that the engaging operation by the engaging device 10 should be executed for restraining the rotation of the rotational element (for example, the motor generator 40) of the power transmission device of the vehicle and the like. When the process at step S01 is completed, the procedure shifts to step S02.

At step S02, the engaging operation is executed in response to an on-state of the engagement instruction at step S01 and the current value (actuator current) flowing through the electromagnetic coil 21 of the electromagnetic actuator 20 is measured. The ECU 30 measures the actuator current by a measuring unit such as a current sensor, for example, to obtain time-series data indicating the temporal transition of the actuator current during the engaging operation. The ECU 30 obtains the time-series data of the actuator current from time t0 at which the engagement instruction is turned on to predetermined measurement termination time t5 after the engaging operation is completed as illustrated in FIG. 4, for example. Meanwhile, as measurement termination time t5, time at which the engaging operation is sufficiently completed even when there is the abnormality in the waiting mechanism spring 28 and before another control performed after the engaging operation starts may be set. In an example in FIG. 4, measurement termination time t5 is set in a time period after time t4 at which the armature 24 arrives at the stroke end at the abnormal time of the waiting mechanism spring 28 and the actuator current reaches the engagement indicator current to sufficiently converge. When the process at step S02 is completed, the procedure shifts to step S03.

At step S03, it is determined whether there is the drop of the actuator current from time t2 to t5 from the time-series data of the actuator current during the engaging operation obtained at step S02. Herein, time t2 is the time by which the armature 24 arrives at the stroke end and the actuator current converges on the engagement indicator current when the waiting mechanism spring 28 is normal as described above, and time t5 is the measurement termination time of the time-series data. As a result of the determination at step S03, if there is the drop of the actuator current from time t2 to t5, the procedure shifts to step S04, and otherwise, it is determined that the waiting mechanism normally acts and this control flow is terminated.

Since it is determined that there is the drop of the actuator current from time t2 to t5 in the time-series data of the actuator current during the engaging operation at step S03, it is determined that the second drop (region A in FIG. 4) occurs after the first drop occurring also at the normal time and determined that some kind of abnormality occurs in the waiting mechanism spring 28 at step S04. When the process at step S04 is completed, the procedure shifts to step S05.

Since it is determined that the abnormality occurs in the waiting mechanism spring at step S04, the releasing operation of the engaging device 10 is executed at step S05. That is to say, the ECU 30 immediately releases the engaged state between the sleeve 12 and the piece 11 to put the sleeve 12 into a state separated from the piece 11 at the abnormal time of the waiting mechanism. When the process at step S05 is completed, the procedure shifts to step S06.

At step S06, a waiting mechanism abnormality flag indicating that some kind of abnormality occurs in the waiting mechanism spring 28 is turned on. In response to this, the ECU 30 informs the driver and the mechanic of the occurrence of the abnormality in the waiting mechanism spring 28 through the indicator 50 and the like mounted on the hybrid vehicle in which the engaging device 10 is installed. The ECU 30 forbids the execution of the engaging operation until the waiting mechanism abnormality flag is turned off such as after repair of the waiting mechanism spring 28 is completed, for example. When the process at step S06 is completed, this control flow is terminated.

Next, an effect of the engaging device 10 according to this embodiment is described.

The engaging device 10 of this embodiment is provided with the piece 11 including the dog teeth 13 arranged around the axis C being a rotational center of the rotational element, the sleeve 12 arranged coaxially with the piece 11 including the dog teeth 14 arranged around the axis C so as to be opposed to the dog teeth 13, the motor generator 40 which relatively rotates the piece 11 and the sleeve 12 around the axis C, the electromagnetic actuator 20 which provides the thrust in the axial direction to the sleeve 12 to move the sleeve 12 in the axial direction, the ECU 30 which performs the engaging operation to engage the sleeve 12 with the piece 11 by meshing the dog teeth 14 with the dog teeth 13 and the releasing operation to release the engaged state between the sleeve 12 and the piece 11 by separating the dog teeth 14 from the dog teeth 13 by controlling the operation of the motor generator 40 and the electromagnetic actuator 20, and the waiting mechanism spring 28 arranged between the electromagnetic actuator 20 and the sleeve 12 which accumulates the thrust in the axial direction provided from the electromagnetic actuator 20 to allow the sleeve 12 to wait for the movement in the axial direction. The ECU 30 may control the position of the sleeve 12 in the axial direction through the waiting mechanism spring 28 according to the magnitude of the current value supplied to the electromagnetic actuator 20. The ECU 30 is configured to feedback-control the current value so as to realize the engagement indicator current required for moving the sleeve 12 to the position in the axial direction in which the dog teeth 14 may mesh with the dog teeth 13 in the engaging operation. The ECU 30 performs the releasing operation based on the temporal transition of the current value during the engaging operation.

By this configuration, it is possible to determine the abnormality in the waiting mechanism spring 28 by estimating the operation of the electromagnetic actuator 20 based on the temporal transition of the current value (actuator current in FIG. 4) supplied to the electromagnetic actuator 20. Therefore, it becomes possible to determine the abnormality in the waiting mechanism spring 28 without directly measuring the operation of the electromagnetic actuator 20, so that it is not required to provide new sensors for determining the abnormality in the waiting mechanism spring 28. In this manner, the engaging device 10 of this embodiment is capable of determining the abnormality in the waiting mechanism spring 28 by a simple configuration. Further, it is possible to inhibit application of an excessive load between the dog teeth 13 and 14 by avoiding direct transmission of the thrust from the electromagnetic actuator 20 to the dog teeth 13 and 14 at the time of the occurrence of the abnormality in the waiting mechanism spring 28 by immediately separating the sleeve 12 from the piece 11 by executing the releasing operation based on the temporal transition of the current value during the engaging operation, so that the durability of the engaging device 10 may be improved.

In the engaging device 10 of this embodiment, the electromagnetic actuator 20 includes the electromagnetic coil 21, the fixed portions (inner yoke 22 and outer yoke 23) arranged around the electromagnetic coil 21, and the armature 24 which forms the magnetic circuit M of the electromagnetic coil 21 together with the fixed portions and operates the sleeve 12 by moving in a predetermined direction (axial direction of the axis C) by the electromagnetic force generated in the magnetic circuit M. The waiting mechanism spring 28 is arranged between the armature 24 and the sleeve 12. The ECU 30 may control the position of the sleeve 12 in the axial direction through the armature 24 and the waiting mechanism spring 28 by controlling the position of the armature 24 in the axial direction according to the magnitude of the current value supplied to the electromagnetic coil 21 of the electromagnetic actuator 20. The ECU 30 performs the releasing operation when there is the drop of the current value (region A in FIG. 4) in the time period after the required time (time t2 in FIG. 4) for the armature 24 to arrive at the predetermined position and for the current value to reach the engagement indicator current at the normal time of the waiting mechanism spring 28 in the temporal transition of the current value during the engaging operation.

By this configuration, it is possible to estimate the moving operation of the armature 24 of the electromagnetic actuator 20 in the axial direction, that is to say, whether the armature 24 temporarily stops during the movement to the stroke end based on the temporal transition of the current value supplied to the electromagnetic actuator 20 (actuator current in FIG. 4) and determine that the abnormality occurs in the waiting mechanism spring 28 when it is estimated that the armature 24 temporarily stops. In order to determine the abnormality in the waiting mechanism spring 28, it is effective to check whether the relative distance between the armature 24 and the sleeve 12 to which both ends of the waiting mechanism spring 28 are connected changes; however, it is possible to estimate this based on the actuator current without directly measuring the stroke amount of the armature 24 in this embodiment, so that it is not required to provide the new sensors on the armature 24 for determining the abnormality in the waiting mechanism spring 28 and it becomes possible to determine the abnormality in the waiting mechanism spring 28 by the simple configuration. The abnormality in the waiting mechanism spring 28 is determined by difference between the normal time and the abnormal time of the waiting mechanism spring 28, that is to say, by presence of the drop of the actuator current (region A in FIG. 4) which does not occur at the normal time in the temporal transition of the actuator current during the engaging operation in this embodiment, so that it is possible to determine whether the abnormality occurs in the waiting mechanism spring 28 with high accuracy. Since the occurrence of the abnormality in the waiting mechanism spring 28 may be determined with high accuracy in this manner, the releasing operation may be performed at appropriate timing during the engaging operation when the abnormality occurs in the waiting mechanism spring 28, so that the durability of the engaging device 10 may be further improved.

The engaging device 10 of this embodiment is provided with the informing unit which informs of the occurrence of the abnormality (indicator 50 mounted on the vehicle and the like) when it is determined that the abnormality occurs in the waiting mechanism spring 28 by the ECU 30. This configuration makes it possible to rapidly inform the driver and the mechanic of the occurrence of the abnormality in the waiting mechanism spring 28, so that stability of the vehicle may be improved.

In the engaging device 10 of this embodiment, when the ECU 30 determines that the abnormality occurs in the waiting mechanism spring 28, this forbids the execution of the engaging operation. This configuration may avoid the application of the excessive load on the dog teeth 13 and 14 by the engaging operation and the releasing operation repeatedly performed by the engaging device 10 in a state in which the waiting mechanism spring 28 is abnormal, so that deterioration such as abnormal abrasion of the dog teeth 13 and 14 may be decreased.

### (Variation)

A variation of this embodiment is next described. Although a configuration in which occurrence of abnormality in a waiting mechanism spring 28 is determined when an actuator current drops twice during engaging operation is illustrated in the above-described embodiment, another determining method based on temporal transition of the actuator current during the engaging operation may also be used.

For example, as illustrated in (b) in FIG. 4, in the temporal transition of the actuator current when there is the abnormality in the waiting mechanism, a lower limit value B of a first drop at time t3 is larger than a lower limit value C of a drop at normal time at time t1. That is to say, a drop amount of the actuator current when there is the abnormality in the waiting mechanism is smaller than that at the normal time. The drop amount of the actuator current is determined according to a stroke amount and a stroke speed of an armature 24. Therefore, when the amount of the first drop is small, this is considered to mean that the armature 24 stops in a position before this arrives at a stroke end.

From above, in this variation, when the amount of the first drop of the actuator current is relatively small, it is determined that the abnormality occurs in the waiting mechanism spring 28 and releasing operation is performed. In more detail, as illustrated in (b) in FIG. 4, when the lower limit value B of the first drop of the actuator current is not smaller than a predetermined threshold, it is determined that the abnormality occurs in the waiting mechanism spring 28. Herein, “the first drop of the actuator current” may also be referred to as the drop of the actuator current occurring in a time period before required time t2 for the armature 24 to arrive at the stroke end and for the actuator current to reach an engagement indicator current at the normal time of the waiting mechanism spring 28.

In this variation, it is possible to determine the occurrence of the abnormality in the waiting mechanism spring 28 with high accuracy by determining the abnormality in the waiting mechanism spring 28 based on difference between the normal time and the abnormal time of the waiting mechanism spring 28, that is to say, the amount of the first drop of the actuator current in the temporal transition of the actuator current during the engaging operation by the above-described configuration. Since it is possible to determine the occurrence of the abnormality in the waiting mechanism spring 28 with high accuracy in this manner, it is possible to perform the releasing operation at appropriate timing during the engaging operation when the abnormality occurs in the waiting mechanism spring 28, therefore, durability of an engaging device 10 may be further improved.

Meanwhile, it is also possible to combine criteria for determining the abnormality in the waiting mechanism spring 28 “when the actuator current drops twice during the engaging operation” in the above-described embodiment and “when the lower limit value B of the first drop of the actuator current is not smaller than the predetermined threshold” in this variation or may combine still another criterion for determination.

Although the embodiment of the present invention is described above, the above-described embodiment is presented as an example and it is not intended to limit the scope of the invention. The above-described embodiment may be carried out in various other modes and may be variously omitted, replaced, and changed without departing from the gist of the invention. The above-described embodiment and the variation thereof are included in the invention recited in claims and equivalents thereof as well as in the scope and gist of the invention.

The waiting mechanism spring 28 applied in the above-described embodiment may be replaced with the waiting mechanism realized by an element other than the spring such as an elastic material such as rubber and urethane and an air damper, for example. Meanwhile, the “waiting mechanism” used in the above-described embodiment is intended to mean a configuration capable of accumulating thrust while allowing a sleeve 12 to wait for movement and energizing the sleeve 12 in an engaging direction by being compressed between the armature 24 and the sleeve 12 to be elastically deformed in a situation in which the thrust is transmitted from the armature 24 to the sleeve 12.

Although a configuration in which a dog tooth 13 of a piece 11 protrudes toward an outer side in a radial direction and a dog tooth 14 of the sleeve 12 protrudes inward from the outer side of the piece 11 in the radial direction is illustrated in the above-described embodiment, positions of the dog teeth 13 and 14 of the piece 11 and the sleeve 12, respectively, may be in another mode. For example, the mode may be such that the dog tooth 13 of the piece 11 and the dog tooth 14 of the sleeve 12 protrude in directions toward each other.

Although a configuration of a so-called dog clutch in which the dog teeth 14 of the sleeve 12 mesh with the dog teeth 13 of the piece 11 is illustrated as the engaging device 10 in the above-described embodiment, this may also be replaced with another engaging element such as a wet multiple disk clutch.

Although a configuration in which the piece 11 rotates and the sleeve 12 linearly moves in one direction is illustrated in the above-described embodiment, this may be in another mode as long as a relative positional relationship between the piece 11 and the sleeve 12 in a rotational direction and a stroke direction may be changed. For example, it may be configured that the sleeve 12 may move in both of the rotational direction and the stroke direction, or it may be configured that not only the sleeve 12 but also the piece 11 move in the stroke direction for relative movement between the piece 11 and the sleeve 12.

Although an electromagnetic actuator 20 is illustrated as a moving unit for moving the sleeve 12 in the stroke direction and a motor generator 40 is illustrated as the configuration to rotate the piece 11 in the above-described embodiment, another power source may also be applied.

The engaging device according to the present invention may inhibit application of an excessive load on the engaging tooth and the engaged tooth when the abnormality occurs in the waiting mechanism by performing the releasing operation based on the temporal transition of the current value supplied to the moving unit during the engaging operation, so that this has an effect of improving the durability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An engaging device comprising:
a first member including engaged teeth arranged around an axis being a rotational center of a rotational element;
a second member including engaging teeth arranged around the axis so as to be opposed to the engaged teeth, the second member being arranged coaxially with the first member;
a rotating unit configured to relatively rotate the first member and the second member around the axis;
a moving unit configured to provide thrust in an axial direction to the second member to move the second member in the axial direction;
a control unit configured to perform engaging operation to engage the second member with the first member by meshing the engaging teeth with the engaged teeth and releasing operation to release an engaged state between the second member and the first member by separating the engaging teeth from the engaged teeth by controlling operation of the rotating unit and the moving unit; and
a waiting mechanism, arranged between the moving unit and the second member, configured to accumulate the thrust in the axial direction provided from the moving unit and configured to allow the second member to wait for movement in the axial direction, wherein
the control unit is configured to control a position of the second member in the axial direction through the waiting mechanism according to magnitude of a current value supplied to the moving unit, configured to feedback-control the current value to realize an engagement indicator current required for moving the second member to a position in the axial direction in which the engaging teeth may mesh with the engaged teeth in the engaging operation, and configured to perform the releasing operation based on temporal transition of the current value during the engaging operation.

2. The engaging device according to claim 1, wherein
the moving unit is an electromagnetic actuator including:
an electromagnetic coil;
a fixed portion arranged around the electromagnetic coil; and
a movable portion forming a magnetic circuit of the electromagnetic coil together with the fixed portion and configured to operate the second member by moving in a predetermined direction by electromagnetic force generated in the magnetic circuit,
the waiting mechanism is arranged between the movable portion and the second member, and
the control unit is configured to control the position of the second member in the axial direction through the movable portion and the waiting mechanism by controlling a position of the movable portion in the axial direction according to the magnitude of the current value supplied to the electromagnetic coil of the electromagnetic actuator and configured to perform the releasing operation when there is a drop of the current value in a time period after time required for the movable portion to arrive at a predetermined position and for the current value to reach the engagement indicator current at normal time of the waiting mechanism in the temporal transition of the current value during the engaging operation.

3. The engaging device according to claim 1, wherein
the moving unit is the electromagnetic actuator including:
the electromagnetic coil;
the fixed portion arranged around the electromagnetic coil; and
the movable portion forming the magnetic circuit of the electromagnetic coil together with the fixed portion and configured to operate the second member by moving in the predetermined direction by the electromagnetic force generated in the magnetic circuit,
the waiting mechanism is arranged between the movable portion and the second member, and
the control unit is configured to control the position of the second member in the axial direction through the movable portion and the waiting mechanism by controlling the position of the movable portion in the axial direction according to the magnitude of the current value supplied to the electromagnetic coil of the electromagnetic actuator and configured to perform the releasing operation when a lower limit value of the drop of the current value occurring in a time period before the time required for the movable portion to arrive at the predetermined position and for the current value to reach the engagement indicator current at the normal time of the waiting mechanism is not smaller than a predetermined threshold in the temporal transition of the current value during the engaging operation.

4. The engaging device according to claim 2, wherein
the moving unit is the electromagnetic actuator including:
the electromagnetic coil;
the fixed portion arranged around the electromagnetic coil; and
the movable portion forming the magnetic circuit of the electromagnetic coil together with the fixed portion and configured to operate the second member by moving in the predetermined direction by the electromagnetic force generated in the magnetic circuit,
the waiting mechanism is arranged between the movable portion and the second member, and
the control unit is configured to control the position of the second member in the axial direction through the movable portion and the waiting mechanism by controlling the position of the movable portion in the axial direction according to the magnitude of the current value supplied to the electromagnetic coil of the electromagnetic actuator and configured to perform the releasing operation when a lower limit value of the drop of the current value occurring in a time period before the time required for the movable portion to arrive at the predetermined position and for the current value to reach the engagement indicator current at the normal time of the waiting mechanism is not smaller than a predetermined threshold in the temporal transition of the current value during the engaging operation.
